(19) United States
(12) Patent Application Publication
(10) Pub. No.: US 2025/0336387 A1
(43) Pub. Date: Oct. 30, 2025

(54) ACTIVE NOISE CONTROL DEVICE, VEHICLE, AND ACTIVE NOISE CONTROL METHOD

(71) Applicant: Panasonic Automotive Systems Co., Ltd., Kanagawa (JP)

(72) Inventor: Mitsuhiro TANI, Osaka (JP)

(73) Assignee: Panasonic Automotive Systems Co., Ltd., Kanagawa (JP)

(21) Appl. No.: 19/184,456

(22) Filed: Apr. 21, 2025

(30) Foreign Application Priority Data
Apr. 24, 2024 (JP) 2024-070925

(51) Int. Cl. G10K 11/178

(52) U.S. Cl. CPC G10K 11/17854; G10K 11/17879

(57) ABSTRACT

An active noise control device includes: a first signal processor that generates a cancellation signal for outputting a cancellation sound for reducing noise in a space inside an automobile, by applying an adaptive filter to a reference signal correlating with the noise; a second signal processor that updates a coefficient of the adaptive filter; and a sample rate converter. The first signal processor operates in cycle T1, the second signal processor operates in cycle T2 that is longer than cycle T1, and the sample rate converter upsamples the coefficient of the adaptive filter updated by the second signal processor and outputs the coefficient upsampled to the first signal processor. Cycle T1 is longer than a difference between maximum and minimum values of a processing time required from when the second signal processor obtains the reference signal to when the second signal processor updates the coefficient of the adaptive filter.

### CROSS REFERENCE TO RELATED APPLICATION

The present application is based on and claims priority of Japanese Patent Application No. 2024-070925 filed on Apr. 24, 2024.

### FIELD

The present disclosure relates to an active noise control device that actively reduces noise by causing a cancellation sound to interfere with the noise.

### BACKGROUND

Active noise control devices are conventionally known that actively reduce noise in a predetermined space by outputting a cancellation sound for canceling the noise from a cancellation sound source using a reference signal that correlates with the noise and an error signal that is based on a residual sound resulting from interference between the noise and a cancellation sound (see, for example, Patent Literatures (PTLs) 1 to 3).

### CITATION LIST

### Patent Literature

PTL 1: International Patent Application Publication No. 2014/006846
PTL 2: Japanese Unexamined Patent Application Publication No. 2022-108195
PTL 3: Japanese Unexamined Patent Application Publication No. 2020-64101

### SUMMARY

The present disclosure provides an active noise control device capable of improving upon the above related art.

An active noise control device according to one aspect of the present disclosure includes: a first signal processor that generates a cancellation signal for outputting a cancellation sound for reducing noise in a space inside a vehicle, by applying an adaptive filter to a reference signal correlating with the noise; a second signal processor that updates a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and a sample rate converter, wherein the first signal processor operates in a cycle T1, the second signal processor operates in a cycle T2 that is longer than the cycle T1, the sample rate converter upsamples the coefficient of the adaptive filter updated by the second signal processor and outputs the coefficient upsampled to the first signal processor, and the cycle T1 is longer than a difference between a maximum value and a minimum value of a processing time required from when the second signal processor obtains the reference signal to when the second signal processor updates the coefficient of the adaptive filter.

An active noise control device according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating the functional structure of an active noise control device according to an embodiment.

FIG. 2 is a flowchart illustrating the operation of the active noise control device according to the embodiment.

FIG. 3 is a first diagram for explaining a delay that occurs in an active noise control device according to a comparative example.

FIG. 4 is a second diagram for explaining a delay that occurs in the active noise control device according to the comparative example.

FIG. 5A is a first diagram for explaining a delay that occurs in the active noise control device according to the embodiment.

FIG. 5B is a second diagram for explaining a delay that occurs in the active noise control device according to the embodiment.

FIG. 6 is a diagram illustrating an example of setting the characteristics of LPFs.

FIG. 7 is a diagram illustrating the functional structure of an active noise control device in the case of correcting a coefficient of an adaptive filter.

### Description of Embodiment

An embodiment will be described in detail below, with reference to the drawings. The embodiment described below shows a general or specific example. The numerical values, shapes, materials, structural elements, the arrangement and connection of the structural elements, steps, the order of steps, etc. shown in the following embodiment are mere examples, and do not limit the scope of the present disclosure. Of the structural elements in the embodiment described below, the structural elements not recited in any one of the independent claims will be described as optional structural elements.

Each drawing is a schematic, and does not necessarily provide precise depiction. In the drawings, structural elements that are substantially the same are given the same reference marks, and repeated description may be omitted or simplified.

### Embodiment

### Structure

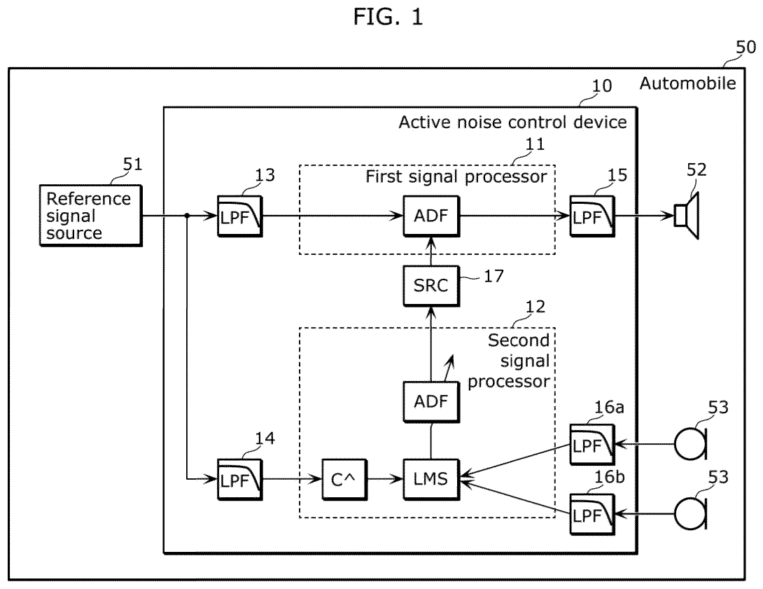

The structure of an active noise control device according to an embodiment will be described below. FIG. 1 is a diagram illustrating the functional structure of the active noise control device according to the embodiment. As illustrated in FIG. 1, automobile 50 includes reference signal source 51, cancellation sound source 52, a plurality of error signal sources 53, and active noise control device 10.

Reference signal source 51 is a transducer that outputs a reference signal correlating with noise in the space inside automobile 50. Reference signal source 51 is, for example, an acceleration sensor, and is located outside the space inside automobile 50. Specifically, reference signal source 51 is attached to a subframe, a wheel well, or the like. The mounting position of reference signal source 51 is not particularly limited. If reference signal source 51 is an acceleration sensor, active noise control device 10 can reduce the road noise component contained in the noise in the space inside automobile 50. Since the propagation path of road noise is complex, a structure in which acceleration sensors are arranged in a plurality of locations is useful. Reference signal source 51 may be a microphone.

Cancellation sound source 52 outputs a cancellation sound to the space inside automobile 50 using a cancellation signal. In the embodiment, cancellation sound source 52 is a speaker. Alternatively, the cancellation sound may be output by vibrating part of the structure of automobile 50 (e.g. a sunroof) by a drive mechanism such as an actuator. A plurality of cancellation sound sources 52 may be installed inside automobile 50. The mounting position of cancellation sound source 52 is not particularly limited.

Error signal source 53 detects a residual sound obtained by interference between the noise and the cancellation sound in the space inside automobile 50, and outputs an error signal based on the residual sound. Error signal source 53 is a transducer such as a microphone, and may be installed in the space inside automobile 50, such as a headliner. Although two error signal sources 53 are installed inside automobile 50 in the example in FIG. 1, the number of error signal sources 53 set inside automobile 50 is at least one.

Error signal source 53 is installed, for example, at a seat inside automobile 50. When one of two error signal sources 53 is installed at the driver's seat and the other of two error signal sources 53 is installed at a back seat, the amount of noise reduction for a user sitting on the driver's seat and the amount of noise reduction for a user sitting on the back seat can be adjusted separately.

Active noise control device 10 generates the cancellation signal for outputting the cancellation sound from cancellation sound source 52, by performing signal processing on the reference signal obtained from reference signal source 51. The cancellation sound is a sound for reducing the noise in the space inside automobile 50. Active noise control device 10 is implemented, for example, by a processor such as a digital signal processor (DSP) or a microcomputer executing a computer program (software) stored in a storage (not illustrated).

Specifically, active noise control device 10 includes first signal processor 11, second signal processor 12, low-pass filters (LPFs) 13 to 15, 16a, and 16b, and sample rate converter 17. First signal processor 11 performs a process of applying an adaptive filter (corresponding to upper “ADF” in FIG. 1). Second signal processor 12 performs a process of generating a filtered reference signal (corresponding to “C\hat{ }” in FIG. 1) and a process of updating the filter coefficient of the adaptive filter (corresponding to “LMS” and lower “ADF” in FIG. 1). Sample rate converter 17 performs sample rate conversion (corresponding to “SRC” in FIG. 1).

Although not illustrated, active noise control device 10 includes an analog-to-digital (AD) converter that converts the reference signal output by reference signal source 51 from an analog signal to a digital signal, a digital-to-analog (DA) converter that converts the cancellation signal output by first signal processor 11 from a digital signal to an analog signal, and an AD converter that converts the error signal output by error signal source 53 from an analog signal to a digital signal. In a structure in which the reference signal and the error signal are input to active noise control device 10 by digital communication and in a structure in which the cancellation signal is output to an external device, these converters may be omitted.

### Operation

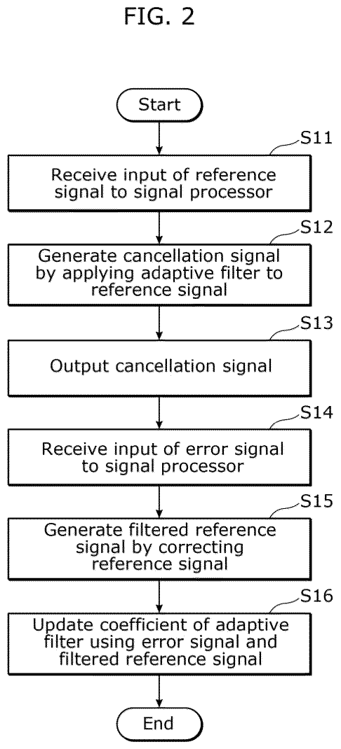

The operation of active noise control device 10 will be described below with reference to FIGS. 1 and 2. FIG. 2 is a flowchart of the operation of active noise control device 10. The following will mainly describe the case where there is one error signal source 53, with supplementary description given to the case where there are a plurality of error signal sources 53.

First, a reference signal correlating with noise is input from reference signal source 51 to active noise control device 10 (S11).

The reference signal input to active noise control device 10 is subjected to LPF 13 and then output to first signal processor 11. The reference signal input to active noise control device 10 is also subjected to LPF 14 and then output to second signal processor 12.

First signal processor 11 generates a cancellation signal by applying an adaptive filter to the reference signal to which LPF 11 has been applied (i.e. convolving the reference signal with the adaptive filter) (S12). First signal processor 11 is implemented by an FIR filter or IIR filter. The cancellation signal generated by first signal processor 11 is subjected to LPF 15 and then output to cancellation sound source 52 (S13). Cancellation sound source 52 outputs a cancellation sound based on the cancellation signal.

Error signal source 53 detects a residual sound resulting from interference between the cancellation sound output from cancellation sound source 52 and the noise, and outputs an error signal corresponding to the residual sound. In other words, the error signal is a signal indicating the state of noise in the space inside automobile 50 when the cancellation sound is being output. As a result, the error signal is input to active noise control device 10 (S14).

The error signal input to active noise control device 10 is subjected to LPF 16a (or LPF 16b) and then output to second signal processor 12.

Second signal processor 12 generates a filtered reference signal by correcting the reference signal using simulated transfer characteristics that simulate the acoustic transfer characteristics from the position of cancellation sound source 52 to the position of error signal source 53 (i.e. the acoustic transfer characteristics in the space inside automobile 50) (S15). For example, the simulated transfer characteristics are measured in the space inside automobile 50 in advance and stored in a storage (not illustrated) included in active noise control device 10. The simulated transfer characteristics may be determined by an algorithm that does not use a predetermined value.

Second signal processor 12 successively updates coefficient W of the adaptive filter based on the error signal to which LPF 16a (or LPF 16b) has been applied and the generated filtered reference signal (S16).

Specifically, second signal processor 12 calculates the coefficient of the adaptive filter so as to minimize the sum of squares of the error signal using a least mean square (LMS) method, and outputs the calculated coefficient of the adaptive filter to first signal processor 11. Second signal processor 12 successively updates the coefficient of the adaptive filter. Let e be the error signal, and R be the vector of the filtered reference signal. Coefficient W of the adaptive filter is then expressed by the following (Formula 1). Here, n is a natural number and represents the nth sample in sampling cycle Ts, and u is a scalar quantity and is a step size parameter that determines the amount of update of coefficient W of the adaptive filter per sampling.

$$\begin{matrix}[ Math . 1 ] & \\ W ( n + 1 ) = W ( n ) - μ e ( n ) R ( n ) . & ( Formula 1 )\end{matrix}$$

If there are two error signal sources 53 in automobile 50, coefficient Woo of the adaptive filter is expressed by the following (Formula 2), where R₀₀₀ and R₀₀₁ are the two filtered reference signals corresponding to two error signal sources 53, e′₀ and e′₁ are the vectors of the two error signals, and μ₀₀₀ and μ₀₀₁ are the step size parameters. Coefficient W₀₀ of the adaptive filter when leak coefficient a is taken into account is expressed by the following (Formula 3).

$$\begin{matrix}[ Math . 2 ] & \\ {W}_{00} ( n + 1 ) = {W}_{00} ( n ) - {μ}_{000} {{e}^{′}}_{0} ( n ) {R}_{000} ( n ) - {μ}_{001} {{e}^{′}}_{1} ( n ) {R}_{001} ( n ) . & ( Formula 2 )\end{matrix}$$

$${W}_{00} ( n + 1 ) = α {W}_{00} ( n ) - {μ}_{000} {{e}^{′}}_{0} ( n ) {R}_{000} ( n ) - {μ}_{001} {{e}^{′}}_{1} ( n ) {R}_{001} ( n ) . \qquad ( Formula 3 )$$

As described above, active noise control device 10 can generate the cancellation signal by applying, to the reference signal, the adaptive filter whose coefficient is updated based on the error signal.

### Delay that Occurs in Active Noise Control Device According to Comparative Example

In active noise control device 10, first signal processor 11 operates in sampling cycle T1, second signal processor 12 operates in sampling cycle T2 that is longer than sampling cycle T1, and sample rate converter 17 upsamples the coefficient of the adaptive filter updated by second signal processor 12 and outputs the upsampled coefficient to first signal processor 11. This can reduce the delay (latency) that occurs in active noise control device 10.

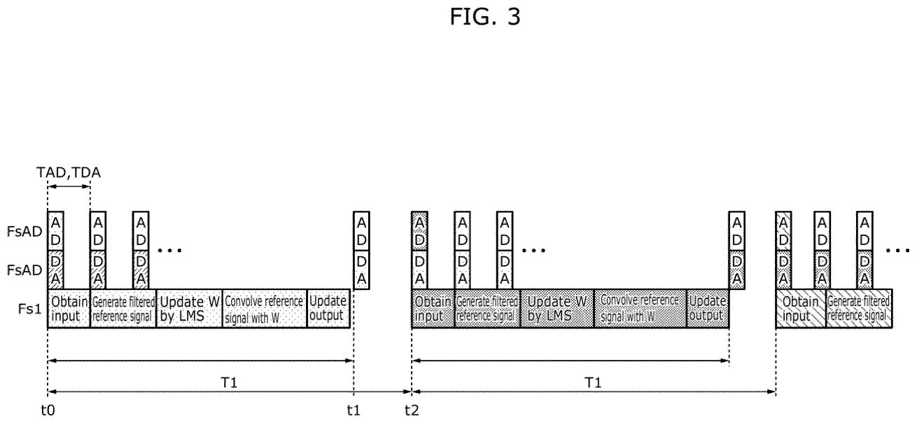

First, a delay that occurs in an active noise control device according to a comparative example in which different sampling cycles are not used unlike in active noise control device 10 will be described. FIG. 3 is a first diagram for explaining a delay that occurs in the active noise control device according to the comparative example. Although FIG. 3 illustrates an example in which the active noise control device operates in periodic processing based on interruption by AD conversion, the type of interruption is not limited to such and may be interruption by TDM transfer. Let FS_B=48 KHz be the interruption frequency. Suppose the reference signal input to the active noise control device is converted to a digital signal in sampling cycle TAD=20.83 μs (sampling frequency FsAD=48 kHz), and the cancellation signal is converted to an analog signal in sampling cycle TDA=20.83 μs (sampling frequency FsDA=48 kHz). The hatching in FIG. 3 indicates the correspondence between the reference signal used in one noise reduction operation and the cancellation signal output as a result of the noise reduction operation.

In the example in FIG. 3, the active noise control device according to the comparative example obtains a reference signal AD-converted at timing to, generates a filtered reference signal, and updates the filter coefficient. The active noise control device also convolves the reference signal AD-converted at timing to with an adaptive filter (filter coefficient), and updates the cancellation signal. As soon as the update of the cancellation signal ends, the active noise control device converts the cancellation signal to an analog signal and outputs it at next DA conversion timing t1. In the example in FIG. 3, sampling frequency Fs1 corresponding to the cycle of obtaining the reference signal is fixed at 3 kHz.

Here, the length of the processing time from when the reference signal is obtained to when the cancellation signal is output is not constant but varies. If the difference (lag) in processing time is longer than the DA conversion timing, the output timing of the cancellation signal is shifted relative to the input reference signal. The output timing of the cancellation signal is sometimes shifted by a length corresponding to several DA conversions. If the delay time changes each time processing is performed, the acoustic transfer characteristics differ from the simulated transfer characteristics measured in advance, causing a decrease in the amount of noise reduction and a decrease in the stability of the noise reduction operation.

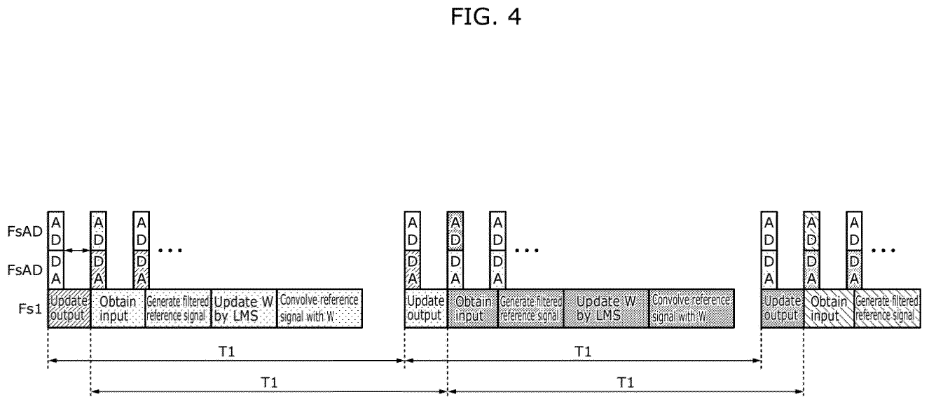

FIG. 4 is a second diagram for explaining a delay that occurs in the active noise control device according to the comparative example. In the example in FIG. 4, the cancellation signal is updated immediately after interruption. This suppresses the shift in the output timing of the cancellation signal. Thus, the decrease in the amount of noise reduction and the decrease in the stability of the noise reduction operation can be reduced compared to the example in FIG. 3. However, since the cancellation sound is output in the next cycle after the reference signal is obtained, a delay of T1=333.3 μs (=1/Fs1) inevitably occurs.

### Delay that Occurs in Active Noise Control Device According to Embodiment

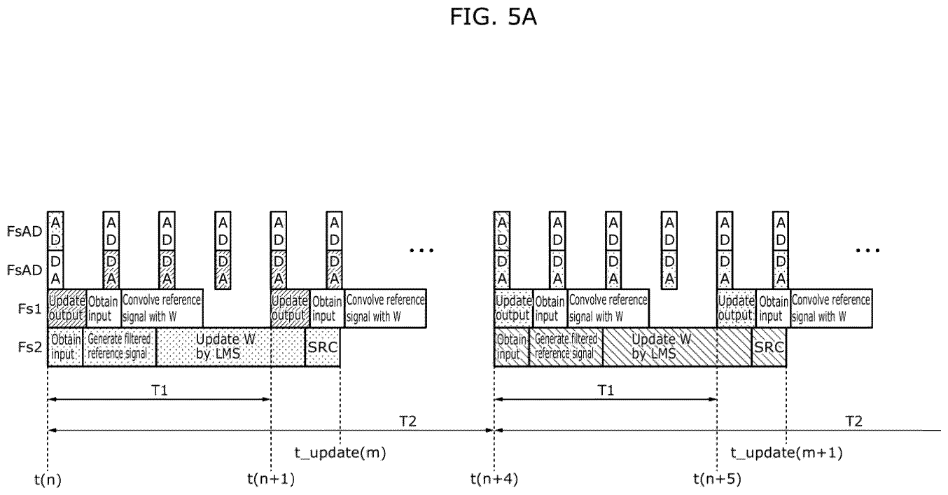

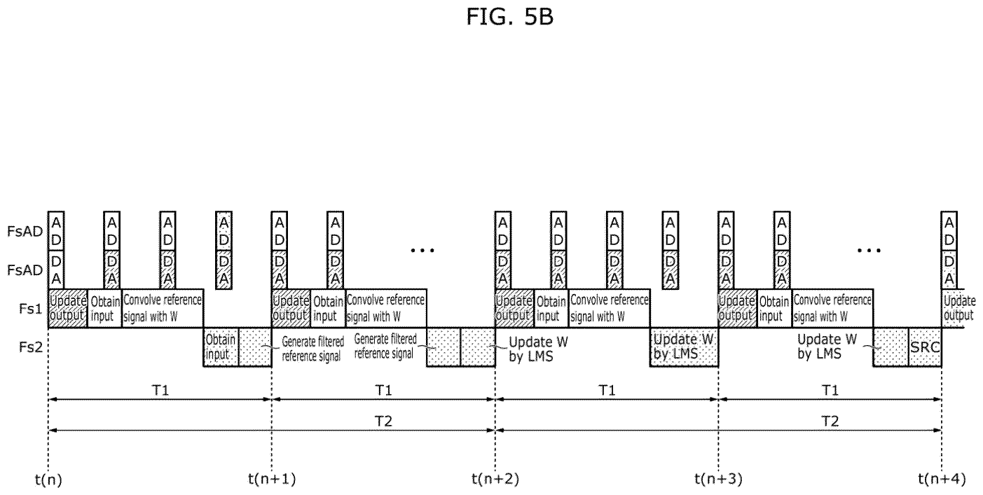

FIG. 5A is a diagram for explaining a delay that occurs in active noise control device 10. In FIG. 5A, suppose the reference signal input to active noise control device 10 is converted to a digital signal in sampling cycle TAD=20.83 μs (sampling frequency FsAD=48 KHz), and the cancellation signal is converted to an analog signal in sampling cycle TDA=20.83 μs (sampling frequency FsDA=48 kHz). The hatching in FIG. 5A indicates the correspondence between the reference signal used in one noise reduction operation and the cancellation signal output as a result of the noise reduction operation.

In FIG. 5A, first signal processor 11 operates in sampling cycle T1=83.3 μs (sampling frequency Fs1=12 kHz), and second signal processor 12 operates in sampling cycle T2=333.3 μs (sampling frequency Fs2=3 kHz) which is longer than sampling cycle T1.

Second signal processor 12 obtains a reference signal AD-converted at timing t (n), generates a filtered reference signal from the obtained reference signal, and updates the filter coefficient. Sample rate converter 17 upsamples the updated filter coefficient and updates the filter coefficient in first signal processor 11. For example, the update of the filter coefficient in first signal processor 11 ends at timing t_update (m) after timing t (n+1) and before timing t (n+2).

Meanwhile, first signal processor 11 obtains a reference signal at AD conversion timing immediately after the end of the cancellation signal update process that started at timing t (n). First signal processor 11 convolves the obtained reference signal with an adaptive filter (filter coefficient) updated at t_update (m-1) (not illustrated) prior to timing t (n), and starts the cancellation signal update process at timing t (n+1). First signal processor 11 outputs the updated cancellation signal at DA conversion timing immediately after the update process ends.

First signal processor 11 obtains a reference signal AD-converted at timing t (n+1), convolves the obtained reference signal with the adaptive filter (filter coefficient) updated at t_update (m), and starts the cancellation signal update process at timing t (n+2) (not illustrated). First signal processor 11 outputs the updated cancellation signal at DA conversion timing immediately after the update process ends.

First signal processor 11 obtains a reference signal AD-converted at timing t (n+2), convolves the obtained reference signal with the adaptive filter (filter coefficient) updated at t_update (m), and starts the cancellation signal update process at timing t (n+3) (not illustrated). First signal processor 11 outputs the updated cancellation signal at DA conversion timing immediately after the update process ends.

First signal processor 11 obtains a reference signal AD-converted at timing t (n+3), convolves the obtained reference signal with the adaptive filter (filter coefficient) updated at t_update (m), and starts the cancellation signal update process at timing t (n+4). First signal processor 11 outputs the updated cancellation signal at DA conversion timing immediately after the update process ends.

First signal processor 11 obtains a reference signal AD-converted at timing t (n+4), convolves the obtained reference signal with the adaptive filter (filter coefficient) updated at t_update (m), and starts the cancellation signal update process at timing t (n+5). First signal processor 11 outputs the updated cancellation signal at DA conversion timing immediately after the update process ends.

Meanwhile, after t_update (m), second signal processor 12 obtains the reference signal AD-converted at timing t (n+4), generates a filtered reference signal from the obtained reference signal, and updates the filter coefficient. Sample rate converter 17 upsamples the updated filter coefficient and updates the filter coefficient in first signal processor 11.

Thus, in active noise control device 10, first signal processor 11 updates the cancellation signal four times while second signal processor 12 updates the filter coefficient once. The delay from when the reference signal is obtained to when the cancellation sound is output is T1=83.3 μs (= 1/12 kHz), which is shorter than 333.3 us in the example in FIG. 4. Hence, active noise control device 10 can reduce the delay from when the reference signal is obtained to when the cancellation sound is output (i.e. the delay associated with the output of the cancellation sound).

Sampling cycles T1 and T2 are merely an example as mentioned above, and first signal processor 11 updates the cancellation signal k times (k is an integer greater than or equal to 2) while second signal processor 12 updates the filter coefficient once in active noise control device 10.

Although FIG. 5A illustrates an example of the processing timings of the first signal processor and the second signal processor in the case where a multi-core processor is applied to active noise control device 10, a single-core processor may be applied to active noise control device 10. FIG. 5B is a diagram illustrating an example of the processing timings in the case where a single-core processor is applied to active noise control device 10.

In FIG. 5A, the signal processing by first signal processor 11 and the signal processing by second signal processor 12 and sample rate converter 17 are executed in parallel. In FIG. 5B, on the other hand, when the signal processing by first signal processor 11 is called during the signal processing by second signal processor 12, the signal processing by second signal processor 12 is suspended and the signal processing by first signal processor 11 is executed, and the signal processing by second signal processor 12 is resumed after the signal processing by first signal processor 11 ends.

In the example in FIG. 5B, first signal processor 11 updates the cancellation signal four times while second signal processor 12 updates the filter coefficient once. The delay from when the reference signal is obtained to when the cancellation sound is output is T1=83.3 μs (= 1/12 kHz), which is shorter than 333.3 us in the example in FIG. 4. Hence, active noise control device 10 to which a single-core processor is applied can also reduce the delay from when the reference signal is obtained to when the cancellation sound is output (i.e. the delay associated with the output of the cancellation sound).

### Setting Examples of Sampling Cycle T1

In the case where active noise control device 10 has a plurality of operation modes such as an operation mode in which noise reduction operation is performed with focus on the seat position and a fail-safe operation mode, the time from when second signal processor 12 obtains the reference signal to when second signal processor 12 updates the adaptive filter (hereafter also referred to as “processing time”) increases or decreases greatly. For example, in the case where the number of adaptive filters increases or decreases for each operation mode, the processing time increases or decreases greatly.

Moreover, in an operation mode in which a relatively large process is added, such as execution of additional calculations, when a certain condition is satisfied, the processing time increases or decreases greatly depending on whether the certain condition is satisfied. For example, in the active noise control device described in PTL 3, a compressor performs compression processing when a reference signal having an amplitude greater than or equal to a threshold is input. Here, the processing time increases or decreases greatly depending on whether the compressor performs compression processing.

In view of this, for example, sampling cycle T1 of first signal processor 11 is set to a time longer than the difference between the maximum and minimum values of the processing time required from when second signal processor 12 obtains the reference signal to when second signal processor 12 updates the coefficient of the adaptive filter. The maximum and minimum values herein refer to the maximum and minimum values when the update process is performed steadily, excluding extreme cases where the update is substantially stopped. The maximum and minimum values may be the maximum and minimum values in specifications.

In this way, even if the processing time increases or decreases, the increase or decrease (variation) in the processing time can be absorbed by the length of sampling cycle T1, so that the delay occurring in active noise control device 10 can be made constant.

Sampling cycle T1 of first signal processor 11 may be set to a time longer than a predetermined time that depends on the variation in the processing time required from when second signal processor 12 obtains the reference signal to when second signal processor 12 updates the coefficient of the adaptive filter. The variation herein refers to the variation when the update process is performed steadily, excluding extreme cases where the update is substantially stopped. For example, the predetermined time that depends on the variation is expressed as the standard deviation of the processing time×N, where N is any positive number, for example, a natural number such as 1, 2, or 3.

In this way, even if the processing time increases or decreases, the increase or decrease (variation) in the processing time can be absorbed by the length of sampling cycle T1, so that the delay occurring in active noise control device 10 can be made constant.

### Setting Examples of LPF Characteristic

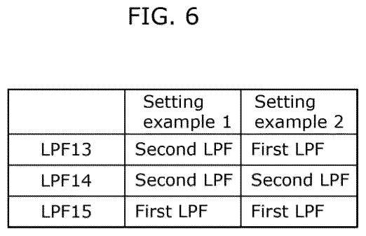

Setting examples of the characteristics of LPFs 13 to 15 will be described. FIG. 6 is a diagram illustrating an example of setting the characteristics of LPFs 13 to 15. LPF 13 is an LPF applied to the reference signal input to first signal processor 11, LPF 14 is an LPF applied to the reference signal input to second signal processor 12, and LPF 15 is an LPF applied to the cancellation signal output from first signal processor 11, as mentioned above.

In setting example 1 illustrated in FIG. 6, a second LPF is used for LPFs 13 and 14 and a first LPF is used for LPF 15.

The first LPF is an LPF that provides a sufficiently large attenuation amount at the Nyquist frequency (sampling frequency×2) of first signal processor 11. In other words, the first LPF is an LPF that provides an attenuation amount less than or equal to a predetermined value at a frequency of 1/(2×T1) where T1 is the sampling cycle of first signal processor 11. The attenuation amount less than or equal to the predetermined value is, for example, an attenuation amount of −60 dB or less (e.g. −80 dB) relative to the gain of the passband. The filter order, etc. of the first LPF are not particularly limited.

The second LPF is an LPF that provides a sufficiently large attenuation amount t the Nyquist frequency (sampling frequency×2) of second signal processor 12. In other words, the second LPF is an LPF that provides an attenuation amount less than or equal to a predetermined value at a frequency of 1/(2×T2) where T2 is the sampling cycle of second signal processor 12. The attenuation amount less than or equal to the predetermined value is, for example, an attenuation amount of −60 dB or less (e.g. −80 dB) relative to the gain of the passband. The filter order, etc. of the second LPF are not particularly limited.

If the second LPF is used for LPFs 13 and 14 and the first LPF is used for LPF 15 as in setting example 1, the group delay can be shortened by relaxing the characteristic of LPF 15 (the LPF applied to the cancellation signal).

In setting example 2 illustrated in FIG. 6, the first LPF is used for LPFs 13 and 15 and the second LPF is used for LPF 14. In setting example 2, the group delay can be shortened by relaxing the characteristics of LPFs 13 and 15 which are located in the path for generating the cancellation signal.

### Correction of Coefficient of Adaptive Filter

In setting example 2, since LPF 13 (first LPF) applied to the reference signal input to first signal processor 11 and LPF 14 (second LPF) applied to the reference signal input to second signal processor 12 differ in characteristic, there is a possibility that the coefficient of the adaptive filter is not optimized and noise reduction performance degrades.

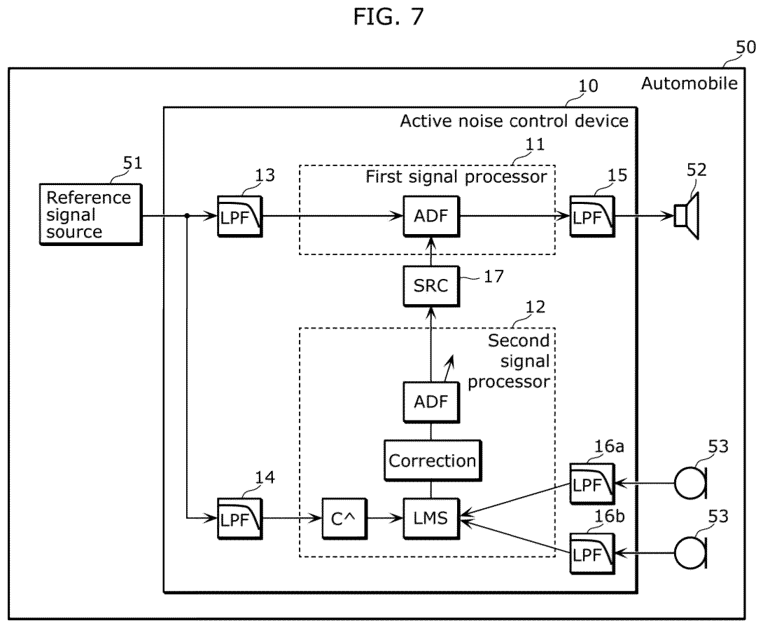

Accordingly, second signal processor 12 may optimize the coefficient of the adaptive filter by correcting the updated coefficient of the adaptive filter based on the attenuation characteristic of the first LPF and the attenuation characteristic of the second LPF. FIG. 7 is a diagram illustrating the functional structure of active noise control device 10 in the case of correcting the coefficient of the adaptive filter.

In FIG. 7, the “Correction” block corresponds to the correction of the coefficient of the adaptive filter by second signal processor 12. Specifically, second signal processor 12 corrects the coefficient of the adaptive filter by convolving the coefficient of the adaptive filter with the inverse characteristic of the second LPF and the characteristic of the first LPF. In other words, second signal processor 12 corrects the difference between the characteristic of LPF 13 (first LPF) and the characteristic of LPF 14 (second LPF). Sample rate converter 17 upsamples the coefficient of the adaptive filter corrected by second signal processor 12 and outputs it to first signal processor 11.

Thus, active noise control device 10 can shorten the group delay while maintaining noise reduction performance.

### Effects, Etc.

The following will give examples of technologies obtained from the disclosure of this specification and describe the effects, etc. achieved by such technologies.

Technology 1 is active noise control device 10 including: first signal processor 11 that generates a cancellation signal for outputting a cancellation sound for reducing noise in a space inside automobile 50, by applying an adaptive filter to a reference signal correlating with the noise; second signal processor 12 that updates a coefficient of the adaptive filter based on a filtered reference signal and an error signal, the filtered reference signal being obtained by correcting the reference signal using simulated transfer characteristics that simulate acoustic transfer characteristics from a position of cancellation sound source 52 that outputs the cancellation sound to a position of error signal source 53, the error signal being obtained from error signal source 53 and indicating a state of the noise when the cancellation sound is being output; and sample rate converter 17, wherein first signal processor 11 operates in cycle T1, second signal processor 12 operates in cycle T2 that is longer than cycle T1, sample rate converter 17 upsamples the coefficient of the adaptive filter updated by second signal processor 12 and outputs the coefficient upsampled to first signal processor 11, and cycle T1 is longer than a difference between a maximum value and a minimum value of a processing time required from when the second signal processor obtains the reference signal to when the second signal processor updates the coefficient of the adaptive filter. Automobile 50 is an example of a vehicle.

Such active noise control device 10 can shorten the delay associated with the output of the cancellation sound while making the delay constant even if the processing time increases or decreases.

Technology 2 is active noise control device 10 including: first signal processor 11 that generates a cancellation signal for outputting a cancellation sound for reducing noise in a space inside automobile 50, by applying an adaptive filter to a reference signal correlating with the noise; second signal processor 12 that updates a coefficient of the adaptive filter based on a filtered reference signal and an error signal, the filtered reference signal being obtained by correcting the reference signal using simulated transfer characteristics that simulate acoustic transfer characteristics from a position of cancellation sound source 52 that outputs the cancellation sound to a position of error signal source 53, the error signal being obtained from error signal source 53 and indicating a state of the noise when the cancellation sound is being output; and sample rate converter 17, wherein first signal processor 11 operates in cycle T1, second signal processor 12 operates in cycle T2 that is longer than cycle T1, sample rate converter 17 upsamples the coefficient of the adaptive filter updated by second signal processor 12 and outputs the coefficient upsampled to first signal processor 11, and cycle T1 is longer than a predetermined time that depends on variation in a processing time required from when the second signal processor obtains the reference signal to when the second signal processor updates the coefficient of the adaptive filter.

Such active noise control device 10 can shorten the delay associated with the output of the cancellation sound while making the delay constant even if the processing time increases or decreases.

Technology 3 is active noise control device 10 according to technology 1 or technology 2, wherein the cancellation signal generated by first signal processor 11 is subjected to a first low-pass filter (LPF) that provides an attenuation amount less than or equal to a predetermined value at a frequency of 1/(2×T1), and the reference signal input to first signal processor 11 and second signal processor 12 is subjected to a second LPF that provides an attenuation amount less than or equal to the predetermined value at a frequency of 1/(2×T2).

Such active noise control device 10 can shorten the group delay (delay associated with the output of the cancellation sound) by relaxing the characteristic of the LPF applied to the cancellation signal.

Technology 4 is active noise control device 10 including: first signal processor 11 that generates a cancellation signal for outputting a cancellation sound for reducing noise in a space inside automobile 50, by applying an adaptive filter to a reference signal correlating with the noise; second signal processor 12 that updates a coefficient of the adaptive filter based on a filtered reference signal and an error signal, the filtered reference signal being obtained by correcting the reference signal using simulated transfer characteristics that simulate acoustic transfer characteristics from a position of cancellation sound source 52 that outputs the cancellation sound to a position of error signal source 53, the error signal being obtained from error signal source 53 and indicating a state of the noise when the cancellation sound is being output; and sample rate converter 17, wherein first signal processor 11 operates in cycle T1, second signal processor 12 operates in cycle T2 that is longer than cycle T1, sample rate converter 17 upsamples the coefficient of the adaptive filter updated by second signal processor 12 and outputs the coefficient upsampled to first signal processor 11, the reference signal input to first signal processor 11 is subjected to a first low-pass filter (LPF) that provides an attenuation amount less than or equal to a predetermined value at a frequency of 1/(2×T1), and the reference signal input to second signal processor 12 is subjected to a second LPF that provides an attenuation amount less than or equal to the predetermined value at a frequency of 1/(2×T2).

Such active noise control device 10 can shorten the group delay (delay associated with the output of the cancellation sound) by relaxing the characteristic of LPF 13 located in the path for generating the cancellation signal.

Technology 5 is active noise control device 10 according to technology 4, wherein second signal processor 12 corrects the coefficient of the adaptive filter updated, based on an attenuation characteristic of the first LPF and an attenuation characteristic of the second LPF, and sample rate converter 17 upsamples the coefficient of the adaptive filter corrected by second signal processor 12 and outputs the coefficient upsampled to first signal processor 11.

Such active noise control device 10 can shorten the group delay (delay associated with the output of the cancellation sound) while maintaining noise reduction performance.

Technology 6 is a vehicle (automobile 50) including: active noise control device 10 according to any of technology 1 to technology 5; reference signal source 51 that outputs the reference signal; cancellation sound source 52; and error signal source 53.

Such a vehicle can shorten the delay associated with the output of the cancellation sound.

Technology 7 is an active noise control method including: generating a cancellation signal for outputting a cancellation sound for reducing noise in a space inside automobile 50, by applying an adaptive filter to a reference signal correlating with the noise; updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of error signal source 53, the error signal being obtained from error signal source 53 and indicating a state of the noise when the cancellation sound is being output; and performing sample rate conversion, wherein the generating is executed in cycle T1, the updating is executed in cycle T2 that is longer than cycle T1, the performing includes upsampling the coefficient of the adaptive filter updated in the updating to enable the coefficient to be used in the generating, and cycle T1 is longer than a difference between a maximum value and a minimum value of a processing time required from when the reference signal is obtained in the updating to when the coefficient of the adaptive filter is updated in the updating.

Such an active noise control method can shorten the delay associated with the output of the cancellation sound while making the delay constant even if the processing time increases or decreases.

Technology 8 is an active noise control method including: generating a cancellation signal for outputting a cancellation sound for reducing noise in a space inside automobile 50, by applying an adaptive filter to a reference signal correlating with the noise; updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of error signal source 53, the error signal being obtained from error signal source 53 and indicating a state of the noise when the cancellation sound is being output; and performing sample rate conversion, wherein the generating is executed in cycle T1, the updating is executed in cycle T2 that is longer than cycle T1, the performing includes upsampling the coefficient of the adaptive filter updated in the updating to enable the coefficient to be used in the generating, and cycle T1 is longer than a predetermined time that depends on variation in a processing time required from when the reference signal is obtained in the updating to when the coefficient of the adaptive filter is updated in the updating.

Such an active noise control method can shorten the delay associated with the output of the cancellation sound while making the delay constant even if the processing time increases or decreases.

Technology 9 is an active noise control method including: generating a cancellation signal for outputting a cancellation sound for reducing noise in a space inside automobile 50, by applying an adaptive filter to a reference signal correlating with the noise; updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of error signal source 53, the error signal being obtained from error signal source 53 and indicating a state of the noise when the cancellation sound is being output; and performing sample rate conversion, wherein the generating is executed in cycle T1, the updating is executed in cycle T2 that is longer than cycle T1, the performing includes upsampling the coefficient of the adaptive filter updated in the updating to enable the coefficient to be used in the generating, the reference signal used in the generating is subjected to a first low-pass filter (LPF) that provides an attenuation amount less than or equal to a predetermined value at a frequency of 1/(2×T1), and the reference signal used in the updating is subjected to a second LPF that provides an attenuation amount less than or equal to the predetermined value at a frequency of 1/(2×T2).

Such an active noise control method can shorten the group delay (delay associated with the output of the cancellation sound) by relaxing the characteristic of LPF 13 located in the path for generating the cancellation signal.

### OTHER EMBODIMENTS

While the embodiment has been described above, the present disclosure is not limited to the above embodiment.

For example, although the active noise control device is a device that performs noise control based on the filtered-x LMS algorithm in the above embodiment, the active noise control device may be implemented as a device that performs noise control based on the single-frequency adaptive notch filter (SAN) algorithm or the SAN filtered-x LMS algorithm.

The active noise control device according to the above embodiment may be installed in a vehicle other than an automobile. The vehicle may be an aircraft or a ship, for example. The present disclosure may be implemented as such vehicle other than an automobile.

The structure of the active noise control device according to the above embodiment is an example. For example, the active noise control device may include structural elements such as a DA converter, a filter, a power amplifier, and an AD converter.

The processing performed by the active noise control device according to the above embodiment is an example. For example, part of the digital signal processing described in the above embodiment may be implemented as analog signal processing.

In the above embodiment, a process executed by a specific processing unit may be executed by another processing unit. The order of a plurality of processes may be changed, and a plurality of processes may be executed in parallel.

Each of the structural elements in the above embodiment may be implemented by executing a software program suitable for the structural element. Each of the structural elements may be implemented by a program executing unit, such as a CPU or a processor, reading and executing the software program recorded on a recording medium such as a hard disk or semiconductor memory.

Each of the structural elements in the above embodiment may be implemented by hardware. For example, the structural elements may be circuits (or integrated circuits). These circuits may constitute one circuit as a whole, or may be separate circuits. These circuits may each be a general-purpose circuit or a dedicated circuit.

The structural elements may be circuits (or integrated circuits). These circuits may constitute one circuit as a whole, or may be separate circuits. These circuits may each be a general-purpose circuit or a dedicated circuit.

The general or specific aspects of the present disclosure may be implemented using a system, a device, a method, an integrated circuit, a computer program, or a computer-readable non-transitory recording medium such as CD-ROM, or any combination of systems, devices, methods, integrated circuits, computer programs, and computer-readable non-transitory recording media.

For example, the present disclosure may be implemented as an active noise control method executed by an active noise control device (computer or DSP), or implemented as a program for causing the computer or DSP to execute the active noise control method. The present disclosure may be implemented as an application program installed in a user interface device. The present disclosure may be implemented as a computer-readable non-transitory recording medium having the program recorded thereon.

Other modifications obtained by applying various changes conceivable by a person skilled in the art to each embodiment and any combinations of the structural elements and functions in each embodiment without departing from the scope of the present disclosure are also included in the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-070925 filed on Apr. 24, 2024.

### INDUSTRIAL APPLICABILITY

The active noise control device according to the present disclosure is useful, for example, as a device capable of reducing automobile interior noise.

1. An active noise control device comprising:
a first signal processor that generates a cancellation signal for outputting a cancellation sound for reducing noise in a space inside a vehicle, by applying an adaptive filter to a reference signal correlating with the noise;
a second signal processor that updates a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
a sample rate converter,
wherein the first signal processor operates in a cycle T1,
the second signal processor operates in a cycle T2 that is longer than the cycle T1,
the sample rate converter upsamples the coefficient of the adaptive filter updated by the second signal processor and outputs the coefficient upsampled to the first signal processor, and
the cycle T1 is longer than a difference between a maximum value and a minimum value of a processing time required from when the second signal processor obtains the reference signal to when the second signal processor updates the coefficient of the adaptive filter.

2. An active noise control device comprising:
a first signal processor that generates a cancellation signal for outputting a cancellation sound for reducing noise in a space inside a vehicle, by applying an adaptive filter to a reference signal correlating with the noise;
a second signal processor that updates a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
a sample rate converter,
wherein the first signal processor operates in a cycle T1,
the second signal processor operates in a cycle T2 that is longer than the cycle T1,
the sample rate converter upsamples the coefficient of the adaptive filter updated by the second signal processor and outputs the coefficient upsampled to the first signal processor, and
the cycle T1 is longer than a predetermined time that depends on variation in a processing time required from when the second signal processor obtains the reference signal to when the second signal processor updates the coefficient of the adaptive filter.

3. The active noise control device according to claim 1,
wherein the cancellation signal generated by the first signal processor is subjected to a first low-pass filter (LPF) that provides an attenuation amount less than or equal to a predetermined value at a frequency of 1/(2×T1), and
the reference signal input to the first signal processor and the second signal processor is subjected to a second LPF that provides an attenuation amount less than or equal to the predetermined value at a frequency of 1/(2×T2).

4. An active noise control device comprising:
a first signal processor that generates a cancellation signal for outputting a cancellation sound for reducing noise in a space inside a vehicle, by applying an adaptive filter to a reference signal correlating with the noise;
a second signal processor that updates a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
a sample rate converter,
wherein the first signal processor operates in a cycle T1,
the second signal processor operates in a cycle T2 that is longer than the cycle T1,
the sample rate converter upsamples the coefficient of the adaptive filter updated by the second signal processor and outputs the coefficient upsampled to the first signal processor, the reference signal input to the first signal processor is subjected to a first low-pass filter (LPF) that provides an attenuation amount less than or equal to a predetermined value at a frequency of 1/(2×T1), and
the reference signal input to the second signal processor is subjected to a second LPF that provides an attenuation amount less than or equal to the predetermined value at a frequency of 1/(2×T2).

5. The active noise control device according to claim 4,
wherein the second signal processor corrects the coefficient of the adaptive filter updated, based on an attenuation characteristic of the first LPF and an attenuation characteristic of the second LPF, and
the sample rate converter upsamples the coefficient of the adaptive filter corrected by the second signal processor and outputs the coefficient upsampled to the first signal processor.

6. A vehicle comprising:
the active noise control device according to claim 1;
a reference signal source that outputs the reference signal;
the cancellation sound source; and
the error signal source.

7. An active noise control method comprising:
generating a cancellation signal for outputting a cancellation sound for reducing noise in a space inside a vehicle, by applying an adaptive filter to a reference signal correlating with the noise;
updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
performing sample rate conversion,
wherein the generating is executed in a cycle T1,
the updating is executed in a cycle T2 that is longer than the cycle T1,
the performing includes upsampling the coefficient of the adaptive filter updated in the updating to enable the coefficient to be used in the generating, and
the cycle T1 is longer than a difference between a maximum value and a minimum value of a processing time required from when the reference signal is obtained in the updating to when the coefficient of the adaptive filter is updated in the updating.

8. An active noise control method comprising:
generating a cancellation signal for outputting a cancellation sound for reducing noise in a space inside a vehicle, by applying an adaptive filter to a reference signal correlating with the noise;
updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
performing sample rate conversion,
wherein the generating is executed in a cycle T1,
the updating is executed in a cycle T2 that is longer than the cycle T1,
the performing includes upsampling the coefficient of the adaptive filter updated in the updating to enable the coefficient to be used in the generating, and
the cycle T1 is longer than a predetermined time that depends on variation in a processing time required from when the reference signal is obtained in the updating to when the coefficient of the adaptive filter is updated in the updating.

9. An active noise control method comprising:
generating a cancellation signal for outputting a cancellation sound for reducing noise in a space inside a vehicle, by applying an adaptive filter to a reference signal correlating with the noise;
updating a coefficient of the adaptive filter based on a filtered reference signal and an error signal, the filtered reference signal being obtained by correcting the reference signal using simulated transfer characteristics that simulate acoustic transfer characteristics from a position of a cancellation sound source that outputs the cancellation sound to a position of an error signal source, the error signal being obtained from the error signal source and indicating a state of the noise when the cancellation sound is being output; and
performing sample rate conversion,
wherein the generating is executed in a cycle T1,
the updating is executed in a cycle T2 that is longer than the cycle T1,
the performing includes upsampling the coefficient of the adaptive filter updated in the updating to enable the coefficient to be used in the generating,
the reference signal used in the generating is subjected to a first low-pass filter (LPF) that provides an attenuation amount less than or equal to a predetermined value at a frequency of 1/(2×T1), and
the reference signal used in the updating is subjected to a second LPF that provides an attenuation amount less than or equal to the predetermined value at a frequency of 1/(2×T2).
